(19) United States
(12) Patent Application Publication
(10) Pub. No.: US 2009/0160160 A1
(43) Pub. Date: Jun. 25, 2009

(54) Adjustable trailer for luggage carriers

(76) Inventors: Rene Bellerose, Sherbrooke (CA); Alexandre Bellerose, Sherbrooke (CA)

Correspondence Address: BCF LLP, 1100 RENE'-LE'VESQUE BLVD. WEST, 25TH FLOOR, MONTREAL, QC, H3B-5C9, CA

(21) Appl. No.: 12/314,332

(22) Filed: Dec. 8, 2008

Related U.S. Application Data
(60) Provisional application No. 60/996,852, filed on Dec. 7, 2007.

(51) Int. Cl. B62D 63/06; B60D 1/155

(52) U.S. Cl. 280/482; 280/789

(57) ABSTRACT

An adjustable trailer for receiving a container, comprising a main member adapted to be attached at a free end thereof to a vehicle, at least one adjustable unit extending transversally of and being connected to the longitudinal main member. A length of the adjustable unit is adapted to be varied. An attachment mechanism is provided for locking the adjustable unit in a selected position. The trailer defines an area for receiving the container, with the width of this area being adapted to be adjusted via the adjustable unit so as to accommodate the container. The container is adapted to be mounted to the trailer.

### FIELD OF THE INVENTION

The present invention generally relates to luggage carriers and/or containers and other articles, such as kayaks. More specifically, the present invention is concerned with a trailer onto which such containers can be fitted and attached.

### BACKGROUND OF THE INVENTION

There exist various types of containers and/or luggage carriers that are intended to be attached atop of a vehicle by means of a vehicle rack. Moreover, such a rack can be used to carry other objects, for example kayaks.

However, there is a need for the containers and/or luggage carriers and other objects to be transported by a means other than a vehicle rack.

### SUMMARY OF THE INVENTION

It is therefore an aim of the present invention to provide a novel trailer for carrying luggage carriers, containers, and the like.

According to the present invention, there is provided an adjustable trailer for luggage carriers, containers and the like.

More specifically, in accordance with the present invention, there is provided an adjustable trailer for receiving a container, the adjustable trailer comprising: a main member adapted to be attached at a free end thereof to a vehicle, at least one adjustable unit extending transversally of and being connected to the longitudinal main member, a length of the adjustable unit being adapted to be varied; attachment means being provided for locking the adjustable unit in a selected position; wherein the trailer defines an area for receiving the container, the width of the area being adapted to be adjusted via the adjustable unit so as to accommodate the container, and the container being adapted to be mounted to the trailer.

The foregoing and other objects, advantages and features of the present invention will become more apparent upon reading of the following non-restrictive description of an illustrative embodiment thereof, given by way of example only, with reference to the accompanying drawings.

### BRIEF DESCRIPTION OF THE DRAWINGS

In the appended drawings:

FIG. 1 is a top perspective view of an adjustable trailer, illustrating a container about to be fitted thereon, in accordance with a non-restrictive illustrative embodiment of the present invention;

FIG. 2 is a top perspective view of the adjustable trailer of FIG. 1, showing the container mounted thereto;

FIG. 3 is a bottom perspective view of the adjustable trailer of FIG. 2, with the container mounted thereon;

FIG. 4 is a side elevation view of the adjustable trailer of FIG. 1;

FIG. 5 is a top plan view of the adjustable trailer of FIG. 1;

FIG. 6 is a front elevation view of the adjustable trailer of FIG. 1; and

FIG. 7 is a top perspective view of the adjustable trailer of FIG. 1, wherein the adjustable trailer is at a minimum width.

### DETAILED DESCRIPTION OF THE INVENTION

An adjustable trailer for luggage carriers according to a non-restrictive illustrative embodiment of the present invention will now be described. Luggage carriers refer herein at least to various closed or open bins and racks that are generally mounted on roofs of vehicles for carrying equipment of all sorts.

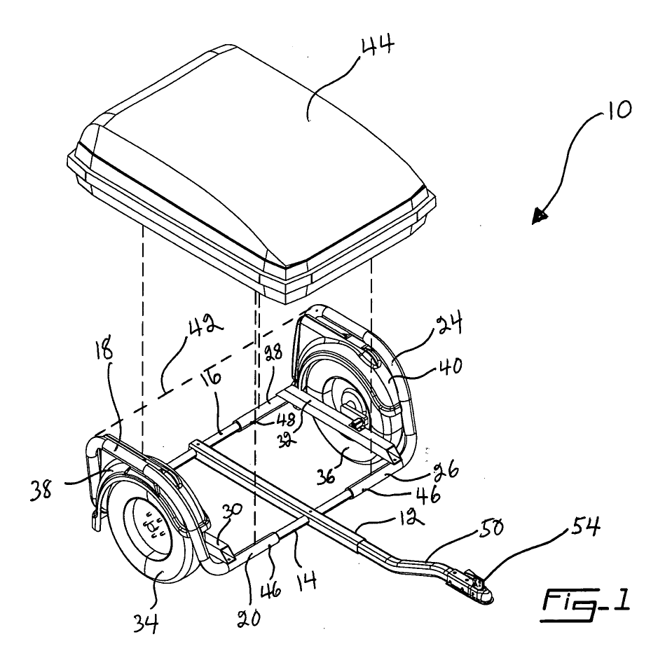

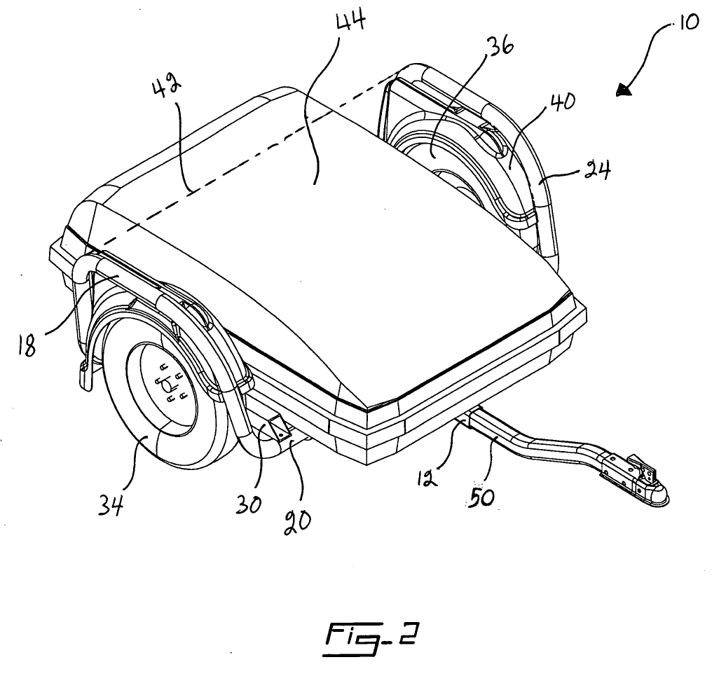

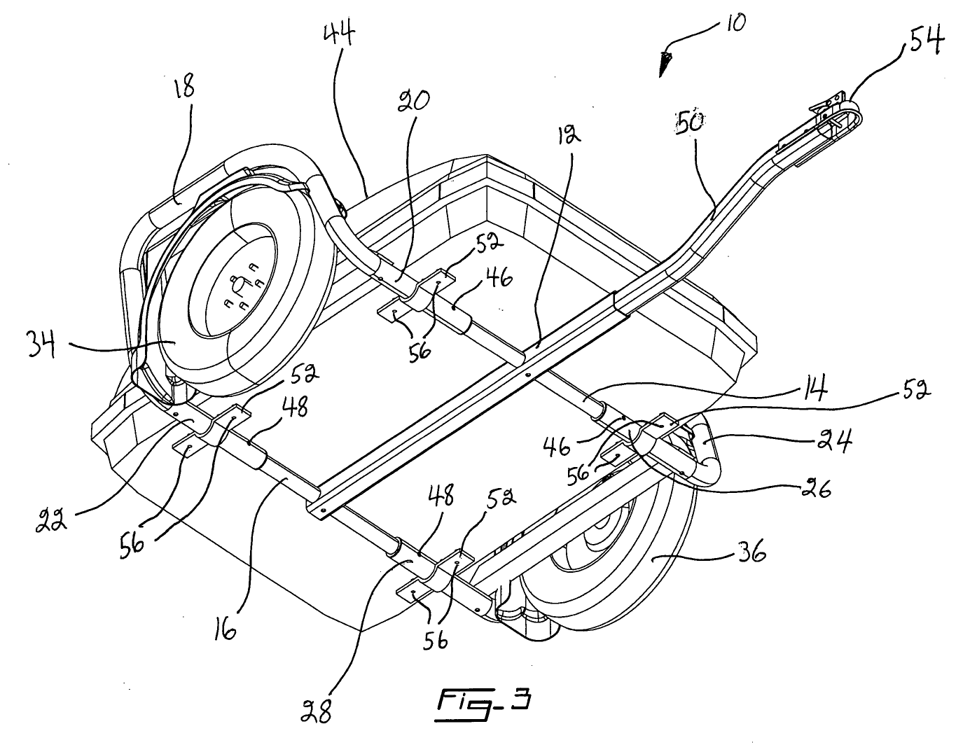

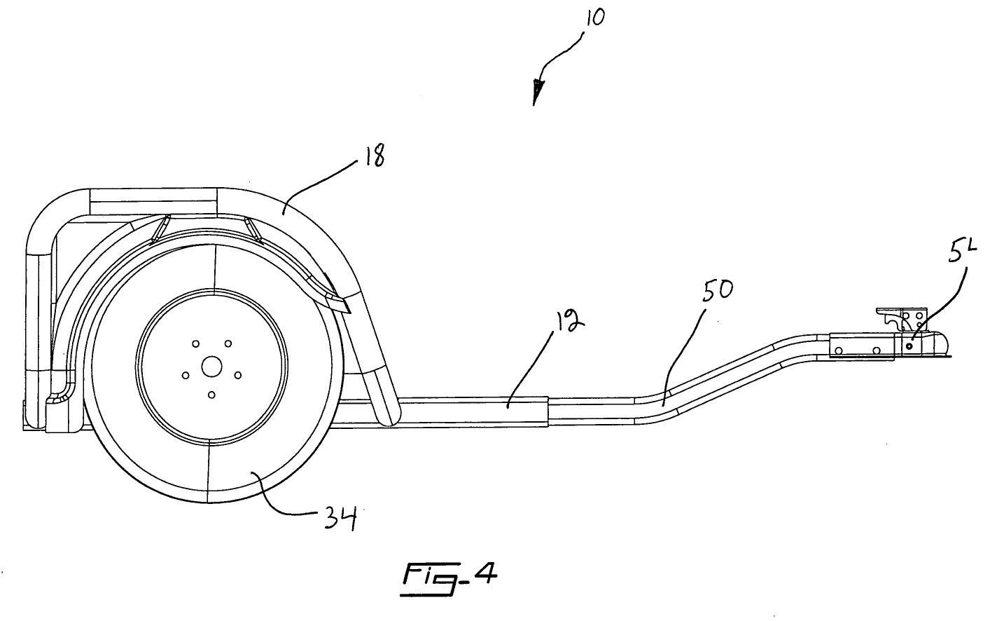

Referring to FIGS. 1 to 3, the adjustable trailer 10 comprises a main longitudinal member 12, to which a front transversal member 14 and a rear transversal member 16 are centrally fixedly attached. Front and rear transversal members 14 and 16 are substantially parallel to one another, and are substantially perpendicular to main longitudinal member 12. Main longitudinal member 12 is configured so as to slidably receive a drawbar 50 at a front end thereof. Referring to FIG. 4, drawbar 50 is secured, at a given length, to main longitudinal member 12, for example by means of a screw (not shown) engaged through a threaded hole (not shown) in main longitudinal member 12. The drawbar 50 includes a trailer hitch coupler 54 at a front end thereof, which is adapted to be herein removably attached to a hitch ball provided on the trailing end of a vehicle (not shown), in a well known manner.

Trailer 10 comprises a right arcuate member 18 from which extend a right front tube 20 and a right rear tube 22. Right front tube 20 and right rear tube 22 are substantially parallel to one another and are so configured as to slidably accommodate respectively a right portion of front transversal member 14 and a right portion of rear transversal member 16.

Similarly, trailer 10 comprises a left arcuate member 24 from which extend a left front tube 26 and a left rear tube 28. Left front tube 26 and left rear tube 28 are substantially parallel to one another and are so configured as to slidably accommodate respectively a left portion of front transversal member 14 and a left portion of rear transversal member 16. The right front tube 20, the front transversal member 14 and left front tube 26 are aligned, as are the right rear tube 22, the rear transversal member 16 and the left rear tube 28.

A right joist 30, substantially parallel to main longitudinal member 12, further fixedly links right front tube 20 and right rear tube 22. Similarly, a left joist 32, substantially parallel to main longitudinal member 12, further fixedly links left front tube 26 and right rear tube 28.

A right wheel 34 and a left wheel 36 are respectively rotatably attached to the right joist 30 and to the left joist 32. A right fender 38 and a left fender 40 are respectively attached to the right arcuate member 18 and to the left arcuate member 24.

Upon assembly, as previously mentioned, the right front tube 20, the front transversal member 14 and the left front tube 26 are collinear. Similarly, the right rear tube 22, the rear transversal member 16 and the left rear tube 28 are collinear.

Since a right portion of front transversal member 14 is slidably inserted into right front tube 20 and a right portion of rear transversal member 16 is slidably inserted into right rear tube 22, a distance between right arcuate member 18 and main longitudinal member 12 can be adjusted. Similarly, since a left portion of front transversal member 14 is slidably inserted into left front tube 26 and a left portion of rear transversal member 16 is slidably inserted into left rear tube 28, a distance between left arcuate member 24 and main longitudinal member 12 can be adjusted. In this manner, a width 42 of adjustable trailer 10 can be adjusted in accordance with the size of, for instance, a luggage carrier or container 44 to be mounted thereon, between the wheels 34 and 36.

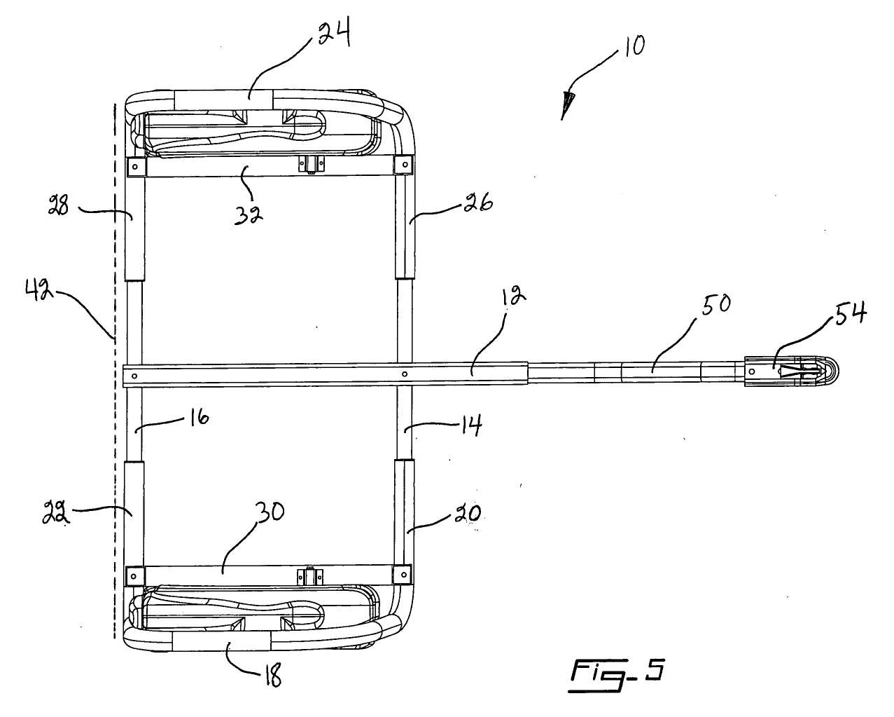

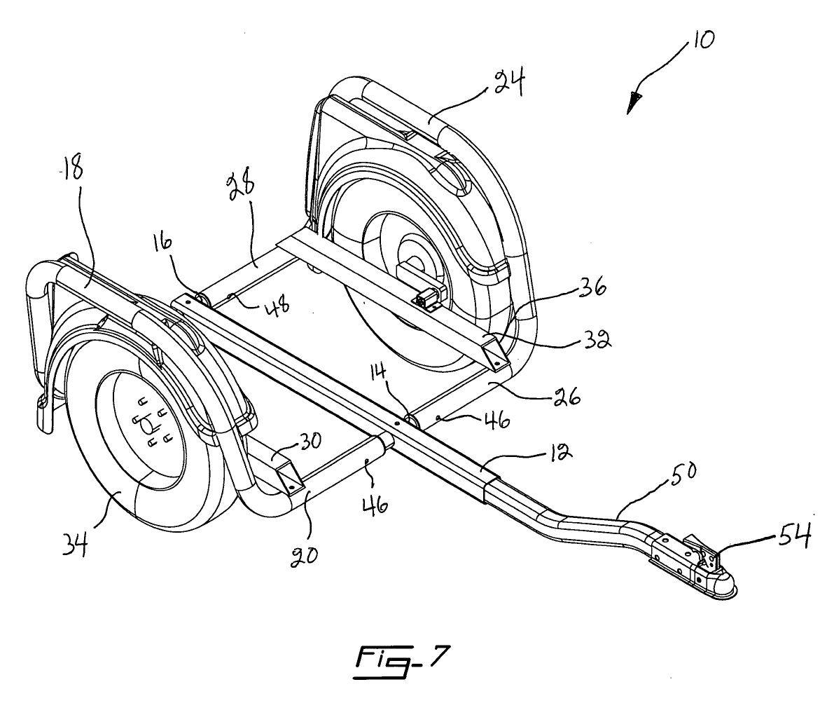

FIGS. 5 to 7 illustrate the adjustable trailer 10, wherein the width 42 varies thereby providing for different trailer widths. More particularly, FIG. 7 illustrates the adjustable trailer 10 in its narrowest state, wherein the width 42 is at a minimum.

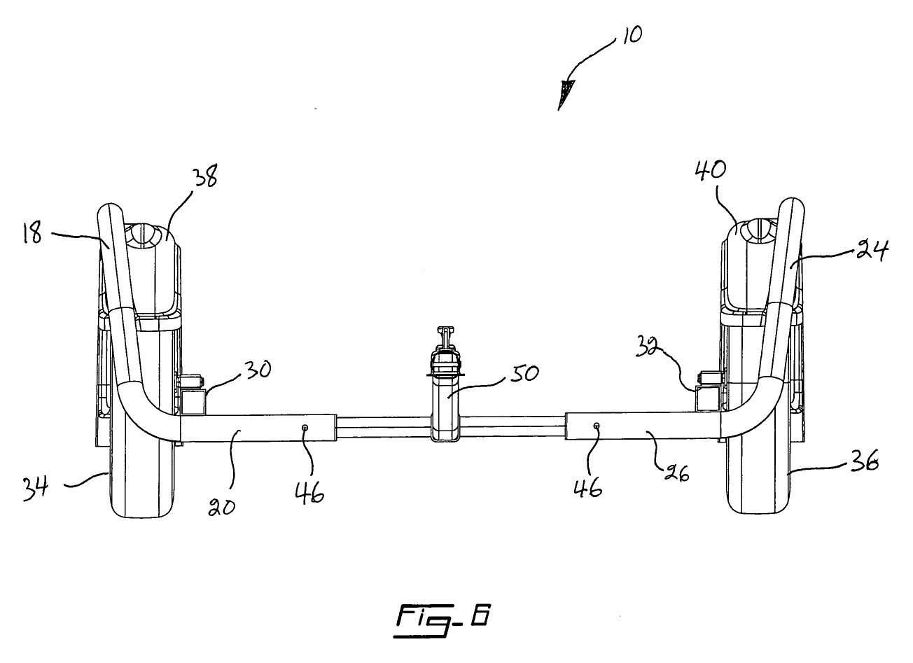

In order to maintain width 42 at a given value, right front tube 20 and left front tube 26 are secured to front transversal member 14 by means of screws (not shown) driven into threaded holes 46 (see FIGS. 6 and 7). Similarly, right rear tube 22 and left rear tube 28 are secured to rear transversal member 16 by means of bolts (not shown) driven into threaded holes 48 (see FIG. 7), with appropriate nuts (not shown) being then securely threadably mounted to these bolts.

In the non-restrictive illustrative embodiment, the container or luggage carrier 44 is attached to trailer 10 by means of support plates 52. Screws (not shown) driven from inside the container 44 into holes 56 defined in the support plates 52 are typically used to secure the container 44 to the support plates 52 and thus to the trailer 10.

It is to be noted that a given container may come with its own fixing means (e.g. U-bolts) so as to be fixed to tubes 20, 22, 26 and 28 of trailer 10.

Although the present invention has been described hereinabove by way of non-restrictive, illustrative embodiments thereof, these embodiments can be modified at will, within the scope of the appended claims, without departing from the spirit and nature of the subject invention.

1. An adjustable trailer for receiving a container, the adjustable trailer comprising: a main member adapted to be attached at a free end thereof to a vehicle, at least one adjustable unit extending transversally of and being connected to the longitudinal main member, a length of the adjustable unit being adapted to be varied; attachment means being provided for locking the adjustable unit in a selected position; wherein the trailer defines an area for receiving the container, the width of the area being adapted to be adjusted via the adjustable unit so as to accommodate the container, and the container being adapted to be mounted to the trailer.
